(19) United States
(12) Patent Application Publication
(10) Pub. No.: US 2006/0153265 A1
(43) Pub. Date: Jul. 13, 2006

(54) Multimode solid laser pumped longitudinally by diodes

(76) Inventors: Stephan Geiger, Prittlbach (DE); Martin Paster, Ebersberg (DE); Siegfried Freer, Germering (DE)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/527,704

(22) PCT Filed: Sep. 10, 2003
(86) PCT No.: PCT/EP03/10056

§ 371 Date: Sep. 15, 2005

(30) Foreign Application Priority Data
Sep. 11, 2002 (DE) 102 41 986.8

(51) Int. Cl. H01S 3/08

(52) U.S. Cl. 372/92

(57) ABSTRACT

Disclosed is a diode-pumped solid-state laser having at least one intracavity positioned laser crystal having at least one optical axis longitudinally to which at least one pumped-light beam emitted from at least one pumped-light source is incident on the laser crystal.

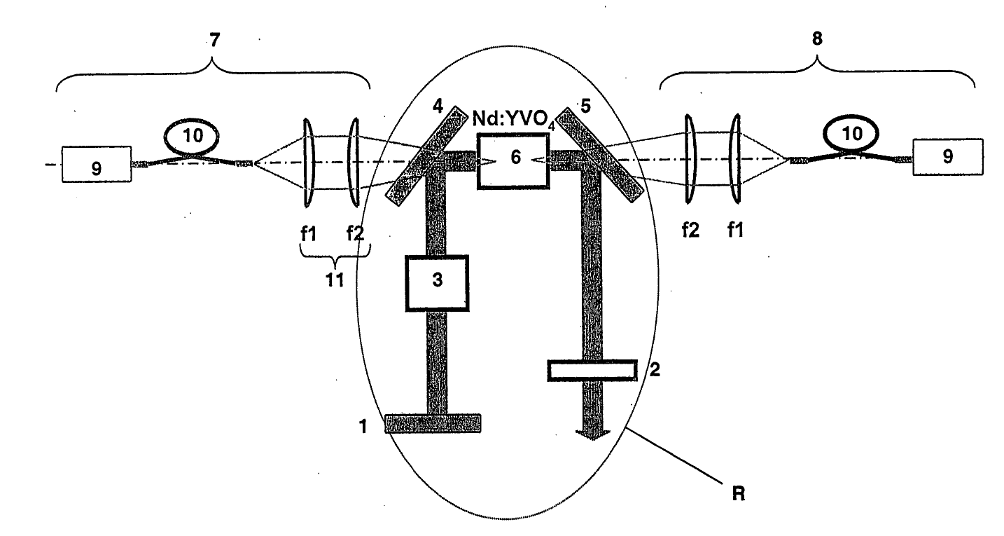

The invention is distinguished by the pumped-light beam having a beam diameter corresponding to at least 1.25 times the beam cross section of a laser beam forming inside the resonator with the oscillation mode TEM₀₀.

### TECHNICAL FIELD

The present invention relates to a diode-pumped solid-state laser having at least one intracavity positioned laser crystal of at least one optical axis, longitudinally to which at least one pumped-light beam emitted by at least one pumped-light source is incident on said laser crystal.

### STATE OF THE ART

Diode-pumped solid-state lasers are high power, compact light sources, which have gained considerable significance with the progress made in the development of laser diodes as pumped-light sources. Meanwhile laser diodes, respectively laser diode systems arranged in lines or array-like, so-called laser diode bars, possessing pumped-light powers of 10 W and more are available. Moreover, these pumped-light sources have emission-wavelength spectra in the range of the optical absorption bands for solid-state lasers, rendering highly efficient optical excitation of laser crystals achievable.

Such type, high power laser diodes open a wide field for optimizing such type optically pumped solid-state laser systems. However, with increasing pumped-light powers, inside the optically pumped laser crystals occur phenomena which limit the gain in the light power emitted by the solid-state laser system.

Thus, high pumped-light power leads to strong pumped-light absorption inside the laser crystal, which at the same time represents a considerable heat charge in the crystal. As the optical refractive power behavior of the laser crystal depending on the type of crystal is more or less temperature dependent, a thermally based lens effect develops correspondingly inside the laser crystal which initially influences the quality of the beam forming inside the laser crystal negatively. Coupled, moreover, with the birefringement setting in, which is connected with the depolarizing effects, this greatly impairs beam power and beam quality.

In addition to this, in striving for solely optical excitation of the TEM₀₀ mode, local hot spots can occur inside the laser crystal, which usually lead to its destruction. Thus the purpose is to focus the pumped light on a focal point inside the laser crystal for monomode optical excitation of the TEM₀₀ mode. The crystal laser must be adapted as closely as possible to the intracavity forming mode of oscillation. Therefore, it is understandable that laser crystals that are sensitive to thermal overheating, such as for example YLF, there are limits set to the desired increase in power when using pumped-light sources.

A particularly suited laser crystal possessing the optical robustness needed for the intended power-increasing measures is Nd:YVO₄(Nd:vanadat). However, with increasing pumped-light power and the heating of the laser crystal entailed therewith, this crystal exhibits an increasingly strongly forming optical lens effect, which, in relation to the intracavity beam course, can be compensated by intelligent resonator design, however the optical aberration caused by the lens effect still remains and has a lasting negative influence on the power performance of the solid-state laser.

U.S. Pat. No. 6,185,235 B1 describes a power-optimized diode-pumped solid state laser having at least one intracavity neodym-vanadat laser crystal, which was conceived with the purpose of generating a high power laser beam with a solely TEM₀₀ beam profile. It is important to provide the laser crystal with only minimum Nd-doping and to ensure that the pumped-light-absorbing laser crystal volume is selected as large as possible, i.e. the longitudinally pumped laser crystal possesses a certain minimum length.

All the hitherto prior art attempts to optimize the power efficiency of longitudinally diode-pumped solid-state lasers concentrate on the declared goal of achieving high light power and at the same time high beam quality, i.e. the oscillation mode forming intracavity is limited to the TEM₀₀ mode. In longitudinally diode-pumped laser systems usually solely beam qualities with M²≦1.2 are realized.

The technical complexity of these high power diode-pumped solid-state lasers makes such laser systems expensive.

Diode-pumped solid-state lasers are fundamentally suited for many different technical fields of application. They are preferably used in areas in which high power, compact laser systems are desired. For example, such type monochromatic light sources are preferably employed for surface material processing, such as material removal, material alteration or surface finishing.

### SUMMARY OF THE INVENTION

The object of the present invention is to provide a diode-pumped solid-state laser which is conceived only with the purpose of as high as possible light power and can be provided as a low cost solid-state laser system. In particular, the object is to provide a diode-pumped solid-state laser system for various types of material processing as well as medical applications. This diode-pumped laser system must possess as high as possible output power, but does not need to have particularly good beam quality.

The solution to the object on which the present invention is based is set forth in claim 1. Advantageous features are the subject matter of the subordinate claims.

A key element of the present invention is that a diode-pumped solid-state laser having an intracavity positioned laser crystal, preferably a neodym-vanadat laser crystal (Nd:YVO₄), having an optical axis longitudinally to which a pumped-light emitted from a pumped light source is incident, is distinguished by the pumped-light beam having a beam diameter corresponding to at least 1.25 times the beam cross section of a laser beam having the oscillation mode TEM₀₀ forming inside the resonator.

Departing from comparable diode-pumped solid-state laser systems, whose pumped light, for the purpose of as high as possible quality on a narrow as possible waisted space inside the laser crystal, is focussed with the aid of a suited imaging optic and the size of whose spot, which is oriented laterally to the beam direction, is adapted to the intracavity forming beam cross section of a TEM₀₀ mode, the invented concept proposes intentionally selecting a substantially larger pumped light cross section imaged inside the laser crystal than the aforementioned beam cross section of a TEM₀₀ mode. If, notably, the ratio of the pumped light beam diameter in the laser crystal to the TEM₀₀ mode diameter is selected greater than 1.25 preferably greater than 1.5 so that in addition to the TEM₀₀ mode, modes of a higher order develop. However, a consequence is that beam quality diminishes to values M²≧1.8. Nonetheless such a beam quality is acceptable for many technical and even medical applications.

As a result of the invented measures, an incomparably higher output power of the laser beam ensues than is the case of only stimulating the oscillations of the TEM₀₀ mode. Although, in addition to increasing power, the invented measures lead to widening the output beam, this is no disadvantage for a number of applications, for example in laser inscriptions on technical surfaces, but rather are desired properties as the larger and wider single signs and letters render the inscription better visible to the eye.

Moreover, due to the invented pumped light beam having a larger cross section than the TEM₀₀ mode forming inside the laser crystal, a larger volume of the laser crystal is illuminated homogeneously, thereby distributing the introduced lost heat more evenly and thus contributing to reducing the thermal lens effect and, in addition, to reducing the thermally induced birefringement. Thus diode-pumped solid-state lasers can be equipped with laser crystals which could not be utilized in the hitherto prevailing power requirements due to the thermal overload.

Fundamentally suited for use of the diode-pumped solid-state laser designed according to the present invention are the following types of laser crystals: Nd:YAG, Nd:YVO₄, Nd:YLF, Nd:GVO₄, Nd:YPO₄, Nd:BEL, Nd:YALO, Nd:LSB, Yb:YAG, Yb:FAB, Cr:LiSAF, Cr:LiCAF, Cr:LiSGAF, Cr:YAG, Tm—Ho:YAG, Tm—Ho:YLF, Br:YAG, Er:YLF or Er:GSGG.

Regarding a technically realizable preferred embodiment reference is made to the sole FIGURE and the description thereof. The sole FIGURE shows a diode-pumped solid-state laser, the resonator R (see broken-line outline) of which is bound by the resonator end mirrors 1 and 2. Provided inside the resonators R is an acousto-optical quality switch 3 and a laser crystal, preferably in the form of a Nd:YVO₄ crystal, positioned between two wave-length selective mirrors 4 and 5. Due to the preset requirements regarding radii of curvature of the resonator end mirrors 1, 2, the optical resonator length and the intracavity positioning of the laser crystal, the optical resonator R of the solid-state laser composed of the preceding components presets the TEM₀₀ mode forming inside the laser crystal and the beam diameter thereof. Further details are given in W. Koechner's book “Solid-State Laser Engineering”, Springer Verlag, 5^{th} ed. 1999, pp. 195 ff.

Furthermore, the solid-state laser shown in the FIGURE is provided with two optical pump arrangements 7,8 positioned relative to the resonator R in such a manner that the pumped-light beams emerging from the pumped-light arrangements 7,8 pump the laser crystal longitudinally. In place of the two pumped-light arrangements 7,8, pumped-light system 7 is provided with a diode laser system 9 emitting a wavelength of 808 nm which lies in the absorption band of the Nd:YVO₄ crystal. The diode-pumped light reaches via an optical fiber arrangement 10 via an imaging optic 11 longitudinally in the laser crystal 6. The imaging optic 11 is provided with optical components f1 and f2 due to which a desired pumped-light beam diameter can be preset inside the laser crystal. Depending on the focal widths of the optical components f1 and f2 and their geometric position in relation to each other, the pumped-light beam can be imaged larger inside the laser crystal 6 than the beam diameter of the TEM₀₀ mode. Thus higher modes TEM₀₁, TEM₁₀, TEM₁₁, etc. are selectively excited, which moreover have a larger beam diameter than the TEM₀₀ mode.

Due to the advantageous manner of double positioning of the pumped-light arrangements 7,8 to both sides of the laser crystal 6, pump efficiency inside the laser crystal can be raised considerably, thereby substantially increasing the power output of the solid-state laser.

In an advantageous manner, the optical resonator is designed as an asymmetrical resonator, for example in the form of a convex-plane, convex-concave or convex-convex resonator construction. The concrete resonator construction occurs tuned to the heating up of the thermal lens effect forming inside the laser crystal under the provision of stable oscillation behavior.

The invented diode-pumped solid-state laser system is fundamentally suited for a multiplicity of different technical fields of application. They are preferably employed in those areas in which high power, compact laser systems are desired. For example, such type monochromatic light sources are used in material processing, preferably for surface material processing, such as material removal, material modification or material finishing. Applications for material processing inside a material volume is also feasible, in which the laser beam is focused on volume regions located inside a material body. Due to the local increase in intensity, melting processes occur in these volume regions, leading to internal cracking in the material.

### LIST OF REFERENCES

1,2 resonator end mirror
3 acousto-optical quality switch
4,5 intracavity semi-reflective mirror
6 laser crystal
7,8 optical pumped-light arrangement
9 diode laser
10 optical fiber arrangement
11 optical imaging system
R resonator

1. Diode-pumped solid-state laser having at least one intracavity positioned laser crystal having at least one optical axis longitudinally to which at least one pumped-light beam emitted from at least one pumped-light source is incident on said laser crystal, wherein said pumped-light beam has a beam diameter corresponding to at least 1.25 times the beam cross section of a laser beam forming inside the resonator with the oscillation mode TEM₀₀.

2. The diode-pumped solid-state laser according to claim 1, wherein the emerging laser beam possesses a beam quality of M²≧1.8.

3. The diode-pumped solid-state laser according to claim 1, wherein said TEM₀₀ mode beam diameter is defined by the mirror radii of the resonator mirrors, the length of said resonator, and said intracavity positioning of said laser crystal, and said beam diameter of said pumped-light beam is adjustable by means of an imaging optic.

4. The diode-pumped solid-state laser according to claim 1, wherein an intracavity quality switch in form of an acousto-opitcal or an electro-optical Q-switch is provided.

5. The diode-pumped solid-state laser according to claim 1, wherein said asymmetrical optical resonator has a convex-plane, convex-concave or convex-convex resonator construction.

6. The diode-pumped solid-state laser according to claim 1, wherein said laser crystal is doped with one or a multiplicity of the following doping substances: Nd, Yb, Cr, Tm, Ho or Er.

7. The diode-pumped solid-state laser according to claim 6, wherein said laser crystal comprises of the following crystals: Nd:YAG, Nd:YVO₄, Nd:YLF, Nd:GVO₄, Nd:YPO₄, Nd:BEL, Nd:YALO, Nd:LSB, Yb:YAG, Yb:FAB, Cr:LiSAF, Cr:LiCAF, Cr:LiSGAF, Cr:YAG, Tm—Ho:YAG, Tm—Ho:YLF, Er:YAG, Er:YLF or Er:GSGG.

8. The diode-pumped solid-state laser according to claim 1, wherein at least one of said pumped-light beams has a power of at least 5 Watt, preferably between 10 and 60 Watt.

9. Use of the diode-pumped solid-state laser according to claim 1 for material processing, preferably for surface processing, such as surface material removal, surface modification, sintering, melting or preferably to process volume material, such as selectively cracking.
